(19) United States
(12) Patent Application Publication
(10) Pub. No.: US 2015/0187382 A1
(43) Pub. Date: Jul. 2, 2015

(54) OPTICAL DISK DEVICE

(71) Applicant: Funai Electric Co., Ltd., Osaka (JP)

(72) Inventors: Masahiro ANDO, Saitama-shi (JP); Yasuhiro NISHINA, Osaka (JP)

(21) Appl. No.: 14/562,975

(22) Filed: Dec. 8, 2014

(30) Foreign Application Priority Data
Dec. 26, 2013 (JP) 2013-268211

(51) Int. Cl. G11B 7/085

(52) U.S. Cl. CPC G11B 7/08582

(57) ABSTRACT

An optical disk device includes an optical pickup unit including a first shaft receptor and a second shaft receptor, a driver that slides the optical pickup unit in a first direction, a main shaft disposed on a driver side and configured to engage the optical pickup unit with the first shaft receptor slidably in the first direction, an auxiliary shaft disposed on an opposite side from the driver and configured to engage the optical pickup unit with the second shaft receptor slidably in the first direction, and a forcing member fixed to the optical pickup unit and in contact with the auxiliary shaft at one tilt position.

### BACKGROUND OF THE INVENTION

1. Field of the Invention

The present invention relates to an optical disk device.

2. Description of the Related Art

An optical disk device is conventionally used to read information recorded on a medium, such as a digital versatile disc (DVD) or a blu-ray disc™ (BD), and to record information on a medium. Such an optical disk device includes an optical pickup unit that moves in a first direction (tracking direction) so as to track information recorded on the medium. The optical pickup unit includes a drive transmission element (tooth) attached thereto to transmit, to the optical pickup unit, a driving force that drives the optical pickup unit to slide in the tracking direction. The optical pickup unit further includes a main shaft receptor and an auxiliary shaft receptor for slidably holding the optical pickup unit respectively against a main shaft and an auxiliary shaft that extend in the tracking direction (see, e.g., JP 2009-3990 A and JP 2010-165396 A).

Low geometrical accuracy of a pickup chassis included in an optical pickup may introduce backlash in engagement between the pickup chassis and the main and the auxiliary shafts. Backlash between the pickup chassis and the main and the auxiliary shafts may cause vibration of the optical pickup, introducing a focus error and/or a tracking error.

### SUMMARY OF THE INVENTION

In view of the problem described above, preferred embodiments of the present invention provide an optical disk device having reduced backlash in engagement between a pickup chassis and main and auxiliary shafts.

According to an aspect of various preferred embodiments of the present invention, an optical disk device includes an optical pickup unit including a first shaft receptor and a second shaft receptor; a driver configured to slide the optical pickup unit in a first direction; a main shaft disposed on a driver side, and configured to engage the optical pickup unit with the first shaft receptor slidably in the first direction; an auxiliary shaft disposed on an opposite side from the driver, and configured to engage the optical pickup unit with the second shaft receptor slidably in the first direction; and a forcing member fixed to the optical pickup unit, and in contact with the auxiliary shaft at one tilt position.

According to the aspect described above of various preferred embodiments of the present invention, a forcing member is attached to the optical pickup unit that slides in the first direction while being held by the main and the auxiliary shafts. The forcing member is in contact with the auxiliary shaft at a tilt position, and a force component in a second direction is thus generated. This significantly reduces or prevents backlash between the optical pickup unit and the main and the auxiliary shafts.

In another aspect of various preferred embodiments of the present invention, the forcing member includes a seating surface, and a plate-shaped portion extending from the seating surface in an oblique direction. The auxiliary shaft is in contact with the forcing member at two points respectively on the seating surface and on the plate-shaped portion.

According to the aspect described above of various preferred embodiments of the present invention, since the forcing member is in contact with the auxiliary shaft at two points, backlash with respect to the main and the auxiliary shafts is effectively reduced or prevented.

In an aspect of various preferred embodiments of the present invention, the forcing member includes a seating surface, and a first plate-shaped portion and a second plate-shaped portion each extending from the seating surface in an oblique direction. The auxiliary shaft is in contact with the first plate-shaped portion and the second plate-shaped portion at two respective points located in an opposed relationship.

According to the aspect described above of various preferred embodiments of the present invention, since the plate-shaped portions are in contact with the auxiliary shaft at two respective points of tilt positions, backlash with respect to the main and the auxiliary shafts is reliably reduced or prevented.

In another aspect of various preferred embodiments of the present invention, when the seating surface is positioned at a reference angle, the plate-shaped portion is in contact with the auxiliary shaft at an angle greater than or equal to about 45 degrees with respect to the seating surface, for example.

In still another aspect of various preferred embodiments of the present invention, the plate-shaped portion includes a protrusion configured to provide point contact with the auxiliary shaft.

According to the aspect described above of various preferred embodiments of the present invention, a reduction in the contact area between the plate-shaped portion and the auxiliary shaft significantly reduces resistance therebetween when the optical pickup unit slides.

The above and other elements, features, steps, characteristics and advantages of the present invention will become more apparent from the following detailed description of the preferred embodiments with reference to the attached drawings.

### BRIEF DESCRIPTION OF DRAWINGS

FIG. 1 is a perspective view illustrating an optical disk device.

FIG. 2 is an exploded perspective view illustrating a drive unit and a chassis.

FIG. 3 is an enlarged view of a portion including a second shaft receptor of a pickup chassis.

FIG. 4 is a perspective view for explaining a configuration of a guide spring.

FIGS. 5A and 5B are each an enlarged cross-sectional view illustrating the guide spring and an auxiliary shaft that are in contact with each other.

FIGS. 6A and 6B are each an enlarged cross-sectional view illustrating the guide spring and the auxiliary shaft that are in contact with each other.

FIG. 7 is an enlarged cross-sectional view illustrating the guide spring and the auxiliary shaft that are in contact with each other.

### DETAILED DESCRIPTION OF THE PREFERRED EMBODIMENTS

Example preferred embodiments of the present invention will be described below with reference to the drawings.

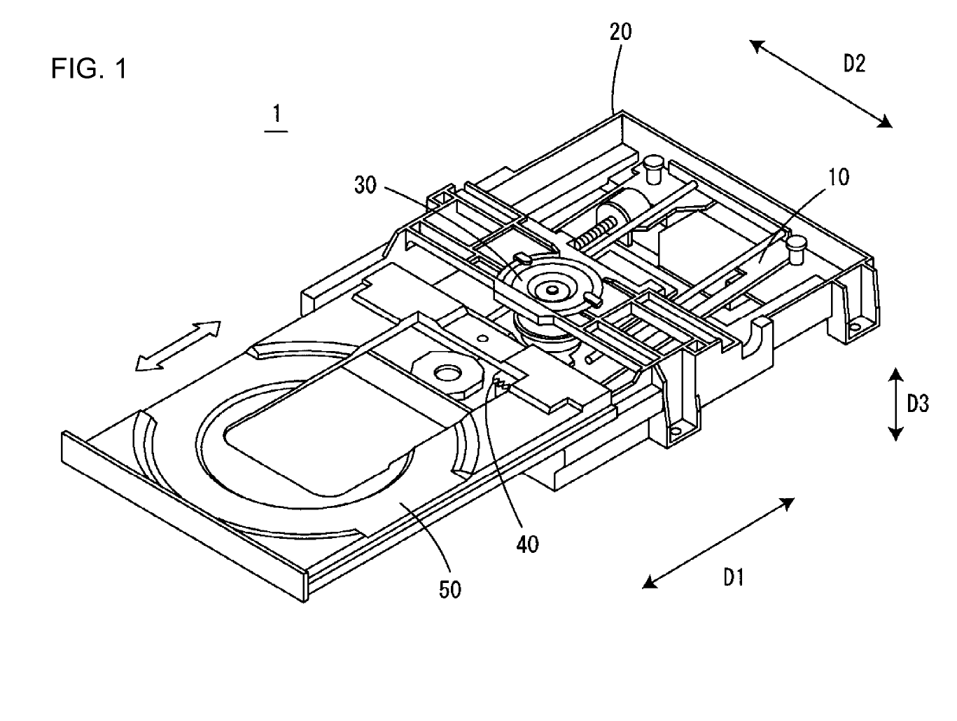

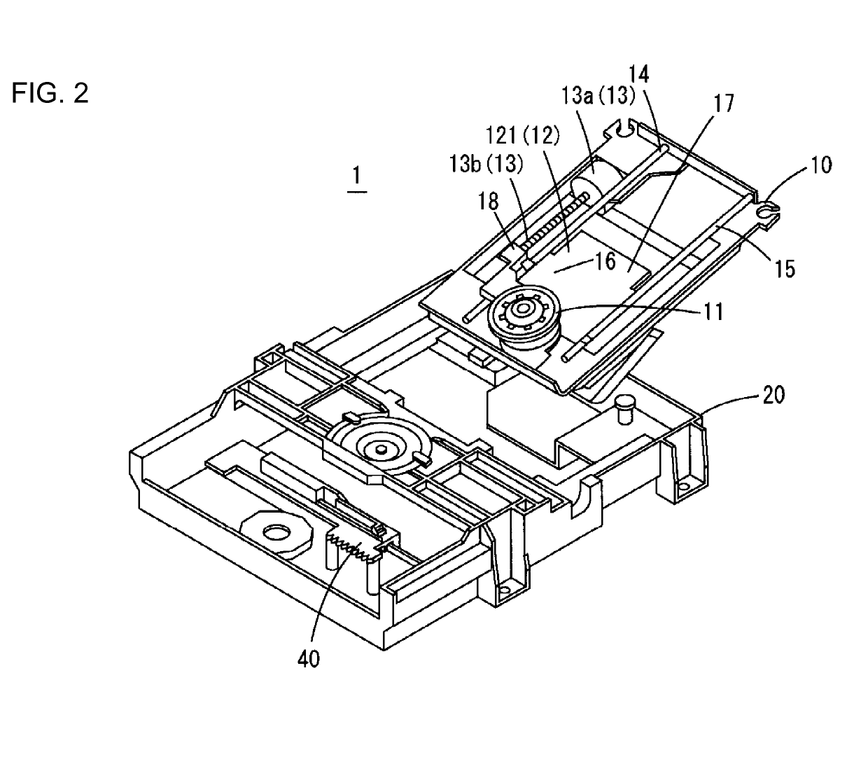

FIG. 1 is a perspective view illustrating an optical disk device 1. FIG. 2 is an exploded perspective view illustrating a drive unit 10 and a chassis 20.

As illustrated in FIGS. 1 and 2, the optical disk device 1 includes the drive unit 10, the chassis 20, a clamper 30, a cam slider 40, and a tray 50. In the optical disk device 1, when a medium is placed on the tray 50 and then the tray 50 is drawn into the chassis 20, a turntable 11 of the drive unit 10 and the clamper 30 together hold the medium. The drive unit 10 reads information on the medium, and outputs the information read through a cable (not illustrated).

In the description given below, the side on which the tray 50 is drawn out of the chassis 20 is referred to as “front side,” and the side on which the tray 50 is received in the chassis 20 is referred to as “rear side.”

In addition, as illustrated in FIG. 2, the drive unit includes the turntable 11, an optical pickup unit 12, a driver 13, a main shaft 14, and an auxiliary shaft 15. In the drive unit 10, while sliding in a tracking direction, the optical pickup unit 12 emits light onto the medium rotating on the turntable 11, and reads information from a reflected light from the medium. In the drive unit 10, a direction in which the optical pickup unit 12 slides is hereinafter referred to as first direction D1 (tracking direction), and a transverse direction (width direction) perpendicular to this first direction D1, a second direction D2. A third direction (focusing direction) of the optical pickup unit 12 is defined as third direction D3.

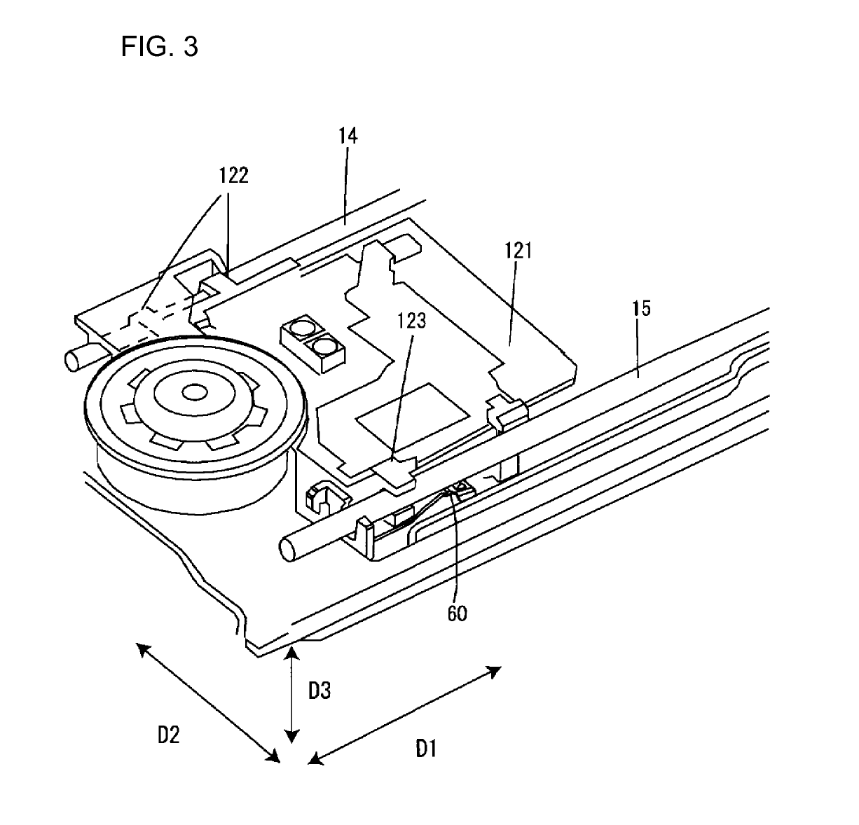

The optical pickup unit 12 includes a pickup chassis 121, to which a tooth 18 and a guide spring (forcing member) 60 (illustrated in FIG. 3 introduced later) are attached. The pickup chassis 121 includes therein an objective lens 16, a semiconductor laser and optical elements which are not illustrated, and a control board 17 that generates digital information based on the reflected light.

The pickup chassis 121 includes, on both sides along the second direction D2 of the pickup chassis 121, a first shaft receptor 122 and a second shaft receptor 123 that respectively engage with the main shaft 14 and the auxiliary shaft 15. The first shaft receptor 122 engages with the main shaft 14 disposed on the driver 13 side along the second direction D2. The second shaft receptor 123 engages with the auxiliary shaft 15 disposed on the opposite side from the driver 13 along the second direction D2. The first shaft receptor 122 has a through-hole structure preferably having a circular cross section. In this preferred embodiment, there are two of the first shaft receptor 122 along the first direction D1, and each of the two first shaft receptors 122 is in contact with the main shaft. The second shaft receptor 123 preferably has an angled U-shaped cross-sectional configuration. The second shaft receptor 123 is in contact with the auxiliary shaft at one point.

The shapes of the first and the second shaft receptors 122 and 123 described above are merely by way of example. Thus, for example, the first shaft receptors 122 may each have an angled U-shaped cross-sectional configuration, and the second shaft receptor 123 may have a through-hole structure having a circular cross section. In this case, the driver 13 preferably is provided on the second shaft receptor 123 side.

The pickup chassis 121 may be made of resin, for example. In this preferred embodiment, the optical pickup unit 12 is assumed to weigh 20 to 30 grams, for example. It should be understood that the material of the pickup chassis 121 and the weight of the optical pickup unit 12 are merely by way of example, and are not intended to be restrictive.

The main shaft 14 and the auxiliary shaft 15 are shaft members each extending along the first direction D1. The first and the second shaft receptors 122 and 123 of the pickup chassis 121 hold the optical pickup unit 12 slidably along the first direction D1 by respectively engaging with the main and the auxiliary shafts 14 and 15.

The driver 13 is fixed to the drive unit 10, and provides power to slide the pickup chassis 121 along the first direction D1. The driver 13 of FIG. 2 includes a thread motor 13a and a screw 13b. The screw 13b threadedly engages with the tooth 18 that is attached to the pickup chassis 121. Thus, rotation of the thread motor 13a causes rotation of the screw 13b, which provides power to slide the pickup chassis 121 along the first direction D1 through the tooth 18. That is, rotation of the screw 13b enables the pickup chassis 121 to slide along the first direction D1 while being held by both the main and the auxiliary shafts 14 and 15.

FIG. 3 is an enlarged view of a portion including the second shaft receptor 123 of the pickup chassis 121. As illustrated in FIG. 3, the pickup chassis 121 has the guide spring 60 attached thereto to reduce backlash between the pickup chassis 121 and the auxiliary shaft 15. The guide spring 60 is in contact with a lower portion of the auxiliary shaft at a tilt position while the optical pickup unit 12 slides along the first direction D1.

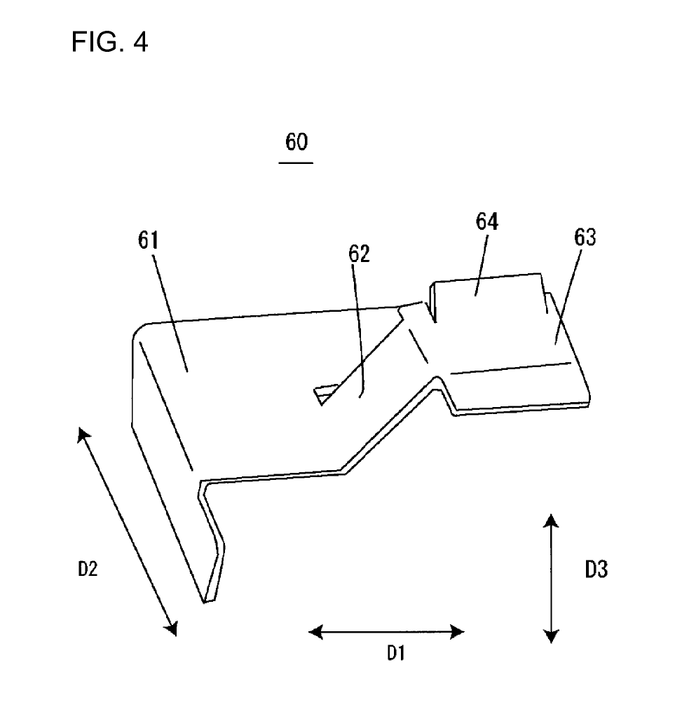

FIG. 4 is a perspective view for explaining a configuration of the guide spring 60 of this preferred embodiment. For purposes of illustration, FIG. 4 illustrates the directions (D1, D2, D3) when the guide spring 60 has been attached to the pickup chassis 121.

The guide spring 60 includes a spring body 61, an arm 62 extending from the spring body 61 in an oblique direction, a seating surface 63 provided at a front edge of the arm 62, a plate-shaped portion 64 extending from one end of the seating surface 63 in an oblique direction. The elements 61 to 64 of the guide spring 60 illustrated in FIG. 4 are formed by, for example, bending a thin sheet metal. It should be understood that the configuration of the guide spring 60 is not limited thereto.

The spring body 61 has a threaded hole (not illustrated) provided therein, and is screwed to the pickup chassis 121. In this preferred embodiment, the spring body 61 is screwed to the pickup chassis 121 so that the plate-shaped portion 64 is directed toward the opening of the tooth 123. The seating surface 63 of the guide spring 60 is disposed under the auxiliary shaft 15, and not in contact with the auxiliary shaft 15.

The seating surface 63 has a certain surface area. The plate-shaped portion 64 is preferably formed by cutting and pulling upward one end along the second direction D2 of the seating surface 63, and thus allowing the plate-shaped portion 64 to extend in an oblique direction.

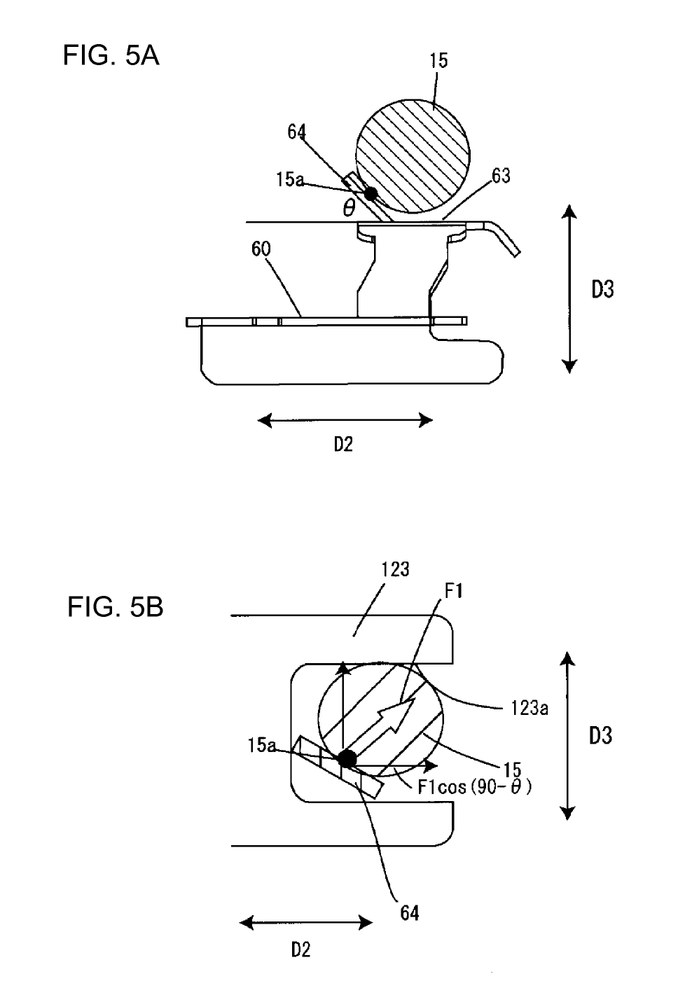

FIGS. 5A and 5B are each an enlarged cross-sectional view illustrating the guide spring 60 and the auxiliary shaft 15 that are in contact with each other. FIG. 5A is a cross-sectional view illustrating the auxiliary shaft 15 in contact with the guide spring 60. FIG. 5B is a schematic view illustrating an arrangement relationship among the auxiliary shaft 15, the second shaft receptor 123, and the guide spring 60. As illustrated in FIG. 5A, the plate-shaped portion 64 of the guide spring 60 is in contact with the auxiliary shaft 15 at a tilt position 15a (one point) of the auxiliary shaft 15. An angle e at which the plate-shaped portion 64 is disposed with respect to the seating surface 63 is preferably about 45 degrees or greater, for example.

As illustrated in FIG. 5B, placing the guide spring 60 in contact with the auxiliary shaft 15 at the tilt position 15a enables backlash between the auxiliary shaft 15 and the second shaft receptor 123 in the third direction D3 to be reduced or prevented. Additionally, a force component F1×cos(90−θ) generated in the second direction D2 in the auxiliary shaft 15 generates a force component in the second direction D2 in the entire optical pickup. This achieves significant reduction in backlash between the auxiliary shaft 15 and the second shaft receptor 123 in the third direction D3, and in backlash between the main shaft 14 and the first shaft receptor 122 in the second direction D2.

As a result, the guide spring 60 significantly reduces backlash with respect to the main and the auxiliary shafts 14 and 15 even when geometrical accuracy of the first shaft receptor 122 and/or the second shaft receptor 123 of the pickup chassis 121 is low. In addition, reduction in backlash with respect to the auxiliary shaft 15 significantly improves traceability of a medium while the optical pickup unit 12 slides in the first direction D1 (tracking direction). Thus, a tracking error and a focus error of the optical pickup unit 12 are significantly reduced or prevented.

A second preferred embodiment of the present invention differs from the first preferred embodiment in that the guide spring 60 is in contact with the auxiliary shaft 15 at two points, that is, at a bottom portion and at a tilt position of the auxiliary shaft 15.

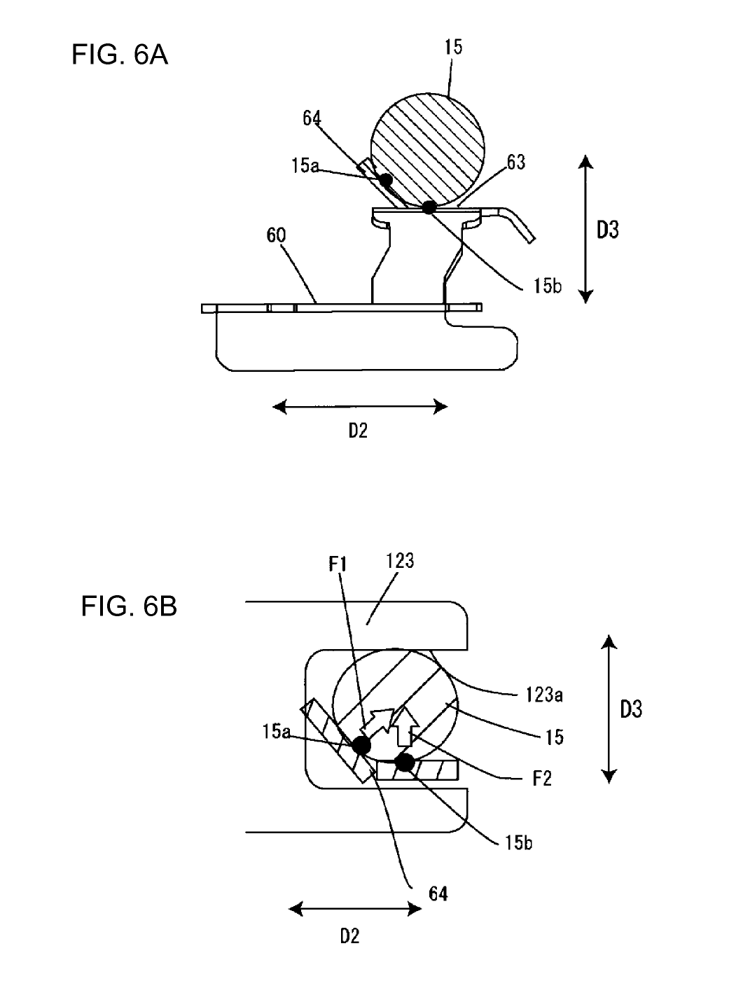

FIGS. 6A and 6B are each an enlarged cross-sectional view illustrating the guide spring 60 and the auxiliary shaft 15 that are in contact with each other. FIG. 6A is a cross-sectional view illustrating the auxiliary shaft 15 in contact with the guide spring 60. FIG. 6B is a schematic view illustrating a geometrical relationship among the auxiliary shaft 15, the second shaft receptor 123, and the guide spring 60. As illustrated in FIG. 6A, the seating surface 63 supports a bottom portion 15b of the auxiliary shaft 15 elongated along the first direction D1. In addition, the plate-shaped portion 64 is in contact with the auxiliary shaft 15 at the tilt position 15a.

As illustrated in FIG. 6B, placing the guide spring 60 in contact with the auxiliary shaft 15 at two points, that is, at the bottom portion 15b and at the tilt position 15a of the auxiliary shaft 15 causes force F1 and F2 to be applied to the auxiliary shaft 15. The force F1 and F2 allows the auxiliary shaft 15 to be reliably pressed toward the groove 123a side of the second shaft receptor 123. Additionally, the force F1 significantly reduces backlash between the main shaft 14 and the first shaft receptor 122 in the second direction D2. Thus, the guide spring 60 effectively reduces or prevents backlash with respect to the main and the auxiliary shafts 14 and 15 even when geometrical accuracy of the first shaft receptor 122 and/or the second shaft receptor 123 of the pickup chassis 121 is low.

A third preferred embodiment of the present invention differs from the other preferred embodiments in that the guide spring 60 preferably includes two plate-shaped portions 64 and 65 extending from the seating surface 63.

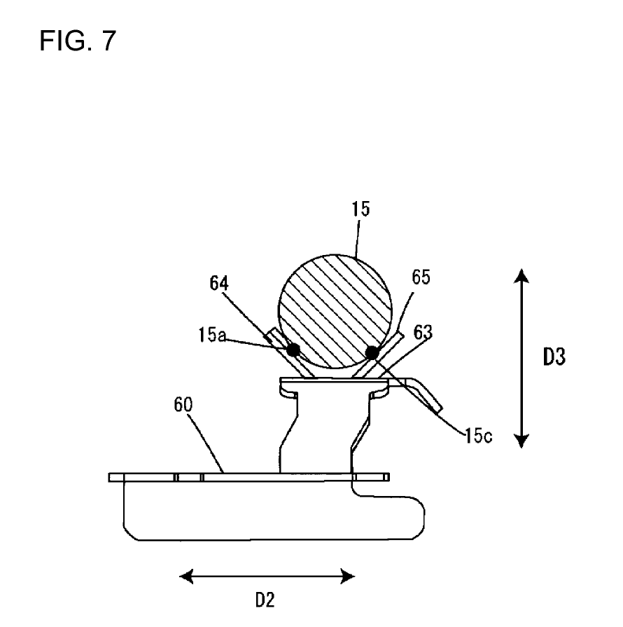

FIG. 7 is an enlarged cross-sectional view illustrating the guide spring 60 and the auxiliary shaft 15 that are in contact with each other. As illustrated in FIG. 7, the plate-shaped portion (first plate-shaped portion) 64 and the plate-shaped portion (second plate-shaped portion) 65 extend from the respective ends along the second direction D2 of the seating surface 63 in an oblique direction. For example, the plate-shaped portions 64 and 65 are each disposed at an angle of about 45 degrees with respect to the seating surface 63.

In the third preferred embodiment, the guide spring 60 is in contact with the auxiliary shaft 15 at tilt positions 15a and 15c located in an opposed relationship via the plate-shaped portions 64 and 65. Placing the guide spring 60 in contact with the auxiliary shaft 15 at two points of the tilt positions 15a and 15c causes a force to be applied so that the auxiliary shaft is pressed toward the groove 123a side of the second shaft receptor 123.

As a result, the guide spring 60 reliably presses the main and the auxiliary shafts 14 and 15 respectively against the first and the second shaft receptors 122 and 123 of the pickup chassis 121 even when geometrical accuracy of the first shaft receptor 122 and/or the second shaft receptor 123 of the pickup chassis 121 is low. Thus, backlash with respect to the main and the auxiliary shafts 14 and 15 is significantly reduced or prevented.

In a fourth preferred embodiment of the present invention, the plate-shaped portion 64 preferably includes a protrusion that protrudes in a middle portion of the plate-shaped portion 64. As an example, the protrusion is preferably formed by bending the plate-shaped portion 64 so as to be elongated in the third direction D3.

Accordingly, when the guide spring 60 is in contact with the auxiliary shaft 15, the tip of the protrusion provides point contact with the auxiliary shaft 15 at a tilt position. Providing the protrusion on the plate-shaped portion 64 reduces the contact area between the plate-shaped portion 64 and the auxiliary shaft 15, and therefore reduces resistance therebetween when the optical pickup unit 12 slides in the first direction D1.

It should be noted that the present invention is not limited to the above-described preferred embodiments.

That is, interchangeable members, configurations, and/or the like disclosed in the above-described preferred embodiments may be applied in a different combination from those of the above-described preferred embodiments, as appropriate.

A well-known member, configuration, and/or the like interchangeable with a member, configuration, and/or the like disclosed in the above-described preferred embodiments may be applied in place of corresponding one(s), or applied in a different combination from those of the above-described preferred embodiments, as appropriate.

A member, configuration, and/or the like that occurs to those skilled in the art based on well-known technology etc. as a replacement of a member, configuration, and/or the like disclosed in the above-described preferred embodiments may be applied in place of corresponding one(s), or applied in a different combination from those of the above-described preferred embodiments, as appropriate.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical disk device comprising:
an optical pickup unit including a first shaft receptor and a second shaft receptor;
a driver configured to slide the optical pickup unit in a first direction;
a main shaft disposed on a driver side and configured to engage the optical pickup unit with the first shaft receptor slidably in the first direction;
an auxiliary shaft disposed on an opposite side from the driver and configured to engage the optical pickup unit with the second shaft receptor slidably in the first direction; and
a forcing member fixed to the optical pickup unit and in contact with the auxiliary shaft at one tilt position.

2. The optical disk device according to claim 1, wherein
the forcing member includes a seating surface and a plate-shaped portion extending from the seating surface in an oblique direction; and
the auxiliary shaft is in contact with the forcing member at two points respectively on the seating surface and on the plate-shaped portion.

3. The optical disk device according to claim 1, wherein
the forcing member includes a seating surface and a first plate-shaped portion and a second plate-shaped portion each extending from the seating surface in an oblique direction; and
the auxiliary shaft is in contact with the first plate-shaped portion and the second plate-shaped portion at two respective points located in an opposed relationship.

4. The optical disk device according to claim 2, wherein when the seating surface is positioned at a reference angle, the plate-shaped portion is in contact with the auxiliary shaft at an angle greater than or equal to about 45 degrees with respect to the seating surface.

5. The optical disk device according to claim 1, wherein the forcing member includes a protrusion configured to provide point contact with the auxiliary shaft.

6. The optical disk device according to claim 1, further comprising a chassis, a clamper, a cam slider, and a tray.

7. The optical disk device according to claim 1, wherein the optical pickup unit includes a pickup chassis, to which a tooth and a guide spring defining the forcing member are attached.

8. The optical disk device according to claim 7, wherein the pickup chassis includes an objective lens, a semiconductor laser and optical elements, and a control board configured to generate digital information based on reflected light.

9. The optical disk device according to claim 1, wherein the first shaft receptor has a through-hole structure having a circular cross section.

10. The optical disk device according to claim 1, wherein the first shaft receptor includes two shaft receptors in contact with the main shaft.

11. The optical disk device according to claim 1, wherein the second shaft receptor has an angled U-shaped cross-sectional configuration.

12. The optical disk device according to claim 1, wherein the first shaft receptor includes two shaft receptors each having an angled U-shaped cross-sectional configuration, and the second shaft receptor has a through-hole structure having a circular cross section.

13. The optical disk device according to claim 1, wherein the driver includes a thread motor and a screw.

14. The optical disk device according to claim 13, wherein the optical pickup unit includes a pickup chassis, to which a tooth and a guide spring defining the forcing member are attached, and rotation of the thread motor causes rotation of the screw, which provides power to slide the pickup chassis along the first direction through the tooth.

15. The optical disk device according to claim 14, wherein the rotation of the screw causes the pickup chassis to slide along the first direction while being held by both the main and the auxiliary shafts.

16. The optical disk device according to claim 7, wherein the guide spring is in contact with a lower portion of the auxiliary shaft at a tilt position while the optical pickup unit slides along the first direction.

17. The optical disk device according to claim 7, wherein the guide spring includes a spring body, an arm extending from the spring body in an oblique direction, a seating surface provided at a front edge of the arm, a plate-shaped portion extending from one end of the seating surface in an oblique direction.

18. The optical disk device according to claim 7, wherein the guide spring is in contact with the auxiliary shaft at a bottom portion and at a tilt position of the auxiliary shaft.

19. The optical disk device according to claim 7, wherein the guide spring includes a seating surface and two plate-shaped portions extending from the seating surface.

20. The optical disk device according to claim 7, wherein the guide spring includes a plate-shaped portion including a protrusion that protrudes in a middle portion of the plate-shaped portion.
